(19) United States
(12) Patent Application Publication
(10) Pub. No.: US 2023/0074944 A1
(43) Pub. Date: Mar. 9, 2023

(54) Fiber-Based Shoe Insoles and Methods of Manufacturing the Same

(71) Applicant: O2 Partners, LLC, Amherst, MA (US)

(72) Inventor: Robert FALKEN, Solana Beach, CA (US)

(73) Assignee: O2 Partners, LLC, Amherst, MA (US)

(21) Appl. No.: 18/055,462

(22) Filed: Nov. 15, 2022

Related U.S. Application Data
(63) Continuation of application No. PCT/US2021/035597, filed on Jun. 3, 2021.
(60) Provisional application No. 63/034,151, filed on Jun. 3, 2020.

(51) Int. Cl. A43B 17/14

(52) U.S. Cl. CPC A43B 17/14

(57) ABSTRACT

A shoe insole includes an insole padding having a bottom surface and a top surface. The insole padding is comprised of vertically oriented non-woven fibers. The non-woven fibers that comprise the insole padding are generally vertically oriented relative to the bottom surface and the top surface of the insole padding.

### CROSS-REFERENCE TO RELATED APPLICATIONS

This application claims the benefit of U.S. Provisional Patent Application No. 63/034,151 filed Jun. 3, 2020 entitled “Machine Washable and Dryable Shoe Insoles and a Method of Manufacturing the Same”, which is incorporated by reference herein in its entirety.

### FIELD OF THE INVENTION

The present invention generally relates to shoe insoles and manufacturing methods thereof and, more particularly, to removable shoe insoles comprised of recyclable and/or biodegradable fibers.

### BACKGROUND OF THE INVENTION

Conventional shoe insoles, also known as sock liners, are typically made from chemical-derived foams such as open-cell polyurethane foam when breathability, also referred to as air permeability, is concerned. Manufacturing open-cell polyurethane foam often requires the use of isocyantate which may be harmful to the environment. Additionally, open-cell polyurethane foam used in the manufacture of shoe insoles requires unlike chemistries of adhesives and fabrics oriented in layered configurations to form the shoe insole. The layered configurations of adhesives and fabrics form a final product that may not be readily recycled or biodegraded. Still further, the use of conventional shoe insoles made from open-cell polyurethane foam require the use of socks to be worn by the shoe wearer to prevent foot odor. Furthermore, the use of adhesives, and chemical-derived foams in the manufacture of conventional shoe insoles may cause the shoe insoles to warp, come apart, and/or tear when being machine washed and/or machine dried. Open-cell foam-based insoles may also retain water when being machine washed that require additional drying in order to remove the water, which may cause the insole to further warp.

### BRIEF SUMMARY OF THE INVENTION

The shoe insole of the present disclosure is a fiber-based shoe insole that is an alternative to traditional foam-based shoe insoles. In one embodiment, the shoe insole includes an insole padding having a bottom surface and a top surface and comprised of non-woven fibers, the non-woven fibers being generally vertically oriented relative to the bottom surface and the top surface of the insole padding. In some embodiments, the shoe insole further includes a knitted cover at least partially encapsulating the insole padding. In some embodiments, the knitted cover is comprised of the same type of fiber as the insole padding. In some embodiments, the knitted cover completely encapsulates the insole padding. In some embodiments, the non-woven fibers are comprised of a recycled material. In some embodiments, the insole is solely held together through mechanical forces and thermal bonding. In some embodiments, the shoe insole does not include any chemical-derived foams or adhesives. In some embodiments, the entire shoe insole is biodegradable. In some embodiments, the entire shoe insole is comprised of a single type of material. In some embodiments, the non-woven fiber is comprised of one or more of cotton, polyester, and nylon.

In some embodiments, the non-woven fiber is comprised of elastomeric polyester fibers. In some embodiments, the insole padding has a specific gravity in a range of about 0.13 g/cm³ to about 0.16 g/cm³. In some embodiments, the insole padding having an air permeance in a range of about 92 μL/Pa·s to about 98 μL/Pa·s. In some embodiments, the insole padding has a thickness in a range of about 4 millimeters to about 6 millimeters. In some embodiments, the insole padding has a thickness of at least 4 millimeters. In some embodiments, the insole padding includes a heel section having a generally concave shape, a toe section which is generally flat, and an arch section being generally convex in shape and extending from the heel section to the toe section.

In one embodiment there is a shoe insole including an insole padding comprised of non-woven fibers comprised of elastomeric polymer fibers, and a cover at least partially encapsulating the insole padding, the cover comprised of knitted elastomeric polymer fibers, the elastomeric polymer fibers of the cover being the same material as the elastomeric polymer fibers of the insole padding. The shoe insole do not include any foam material or adhesives and the insole padding has an air permeance in a range of about 92 μL/Pa·s to about 98 μL/Pa·s and a thickness in a range of about 4 millimeters to about 6 millimeters. In some embodiments, the non-woven fibers of the are generally vertically oriented relative to a bottom surface of the insole padding.

In one embodiment, there is a method of forming a fiber-based shoe insole including providing a plurality of discontinuous fibers, arranging, separating and orienting the discontinuous fibers form a plurality of parallel oriented fibers, batting the plurality of parallel oriented fibers into a sheet of padding having a top surface and a bottom surface, the parallel oriented fibers being generally vertically oriented relative to the bottom surface and the top surface of the sheet of padding, and cutting the sheet of padding into a desired insole shape. In some embodiments, the method further includes encasing the sheet of padding formed into the desired insole shape in a knitted cover. In some embodiments, batting the parallel oriented fibers includes partially intertwining the parallel oriented fibers. In some embodiments, no chemical blowing agents are used to form the sheet of padding. In some embodiments, the desired insole shape generally matches the shape of a bottom of a user's foot. In some embodiments, the arranging, separating, and orienting steps are performed by a carding machine.

In some embodiments, forming the sheet of padding into the shoe insole includes machine die-cutting the sheet of padding. In some embodiments, the plurality of discontinuous fibers is comprised of a recycled fiber. In some embodiments, the entire shoe insole is biodegradable. In some embodiments, the entire shoe insole does not include any chemical-derived flexible foams or adhesives. In some embodiments, the entire shoe insole is comprised of a single type of material. In some embodiments, the sheet of padding is molded into the desired insole shape. In some embodiments, batting the plurality of parallel oriented fibers into a sheet of padding includes thermally bonding the plurality of parallel oriented fibers.

### BRIEF DESCRIPTION OF THE SEVERAL VIEWS OF THE DRAWINGS

The foregoing summary, as well as the following detailed description of embodiments of the fiber-based shoe insoles and methods of manufacturing the same, will be better understood when read in conjunction with the appended drawings of the exemplary embodiments. It should be understood, however, that the invention is not limited to the precise arrangements and instrumentalities shown.

In the drawings:

FIG. 1A is a perspective view of a fiber-based shoe insole in accordance with an exemplary embodiment of the present disclosure;

FIG. 1B is a cross-sectional schematic view of vertically oriented parallel fibers comprising a portion of the fiber-based shoe insole of FIG. 1A;

FIG. 2A is a perspective view of the fiber-based shoe insole of FIG. 1A encased in an optional sock-like cover;

FIG. 2B is a cross-sectional schematic view of the fiber-based shoe insole shown in FIG. 2A;

FIG. 3 is a diagram illustrating a system for forming the shoe insole padding and encasing it within the sock-like structure of FIG. 2B in accordance with an exemplary embodiment of the present disclosure; and

FIG. 4 is a method flowchart illustrating a method of making the fiber-based shoe insole of FIG. 1A in accordance with an exemplary embodiment of the present disclosure.

### DETAILED DESCRIPTION

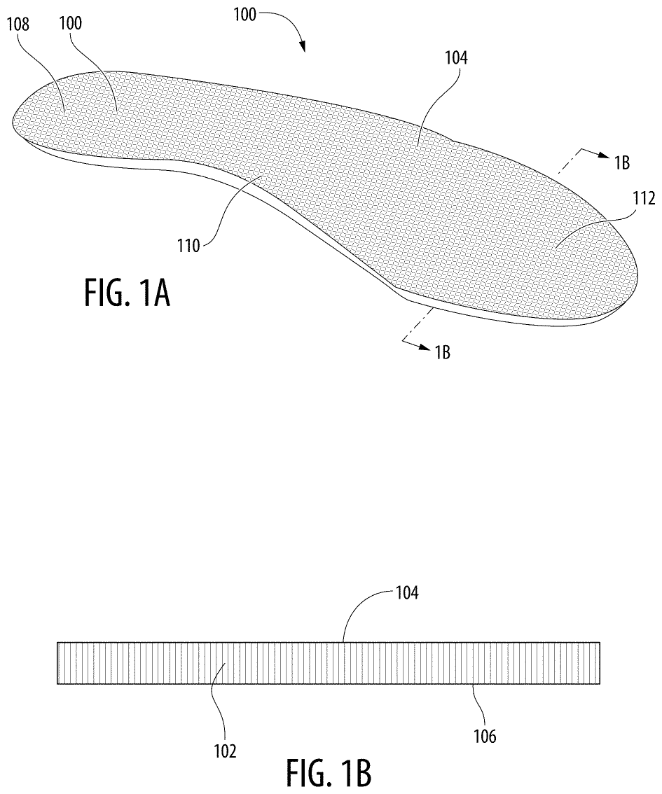

Referring to the drawings in detail, wherein like reference numerals indicate like elements throughout, there is shown in FIGS. 1A— 2B a fiber-based shoe insole, generally designated 100, in accordance with an exemplary embodiment of the present invention.

The shoe insole 100 is a fiber-based shoe insole that is an alternative to traditional foam-based shoe insoles. The shoe insole 100 may be comprised of non-woven fibers. As opposed to conventional shoe insoles, the shoe insoles 100 may be free from chemicals and/or chemical-derived flexible foams and adhesives to decrease the environmental impact of manufacturing and disposing the shoe insoles 100. The fibers used to form the insole padding may be comprised of recycled fibers and/or biodegradable fibers. The configuration, orientation, and/or material used in the non-woven fibers as described in further detail below may allow the shoe insole to have compression, rebound, and/or air permeance properties which are equal to or greater than conventional flexible foam based insoles. The fibers used to form the insole padding may allow the shoe insole to be easily machine washed and/or dried. Additionally, the lack of chemicals, chemical-derived flexible foams, and/or adhesives may allow the shoe insole to be machine washed and/or machine dried without warping or tearing the shoe insole. The shoe insoles may optionally include sock-like covers which encapsulate the insole padding, thereby replacing the need for a wearer to wear socks and/or increasing comfort to the wearer while reducing the wearer's environmental impact.

Referring to FIGS. 1A-1B, in one embodiment, there is shown a shoe insole 100 which may include an insole padding 102. In some embodiments, the shoe insole 100 is a padded layer for use in a shoe (not shown) under the user's foot and may be configured to be removable from the shoe. In some embodiments, the insole padding 102 may be configured to be machine washable and/or machine dryable such that the shoe insole 100 may be machine washed and/or machine dried before being reinserted into a shoe. In some embodiments, the machine washable and/or machine dryable aspects of the insole padding 102 may be achieved by way of not including any foam material and/or chemical-derived flexible foams used in conventional shoe insole padding. In some embodiments, by not including the use of chemical-derived flexible foams, the insole padding 102 may not include any chemical blowing agents used in conventional flexible foam manufacturing.

The insole padding 102 may be comprised of non-woven fibers. The insole padding 102 may have a foam-like structure while being comprised of fibers. For example, the fibers may be oriented (e.g., intertwined and/or thermally bonded to adjacent fibers) in such a way to form a foam-like fiber structure. In other words, the insole padding 102 may allow insole padding 102 to have rebound and compression properties while maintaining breathability, also known as air permeability. The fiber structure may be a voluminous, lofted, three-dimensional nonwoven structure in which fibers are oriented generally vertically such that the insole padding 102 may resist a repeating load from a user standing on the insole padding 102 and who's feet apply pressure downward onto the fibers comprising the insole padding 102.

In some embodiments, non-woven fibers are generally vertically oriented (as shown schematically in FIG. 1B). Vertically oriented fibers, as discussed herein, may refer to fibers which are generally oriented in a vertical direction which is generally perpendicular to a top surface 104 and bottom surface 106 of the insole padding 102. In some embodiments, generally all of the fibers comprising insole padding 102 are vertically oriented. In some embodiments, at least 99% of the fibers comprising the insole padding 102 are vertically oriented. In some embodiments, at least 98% of the fibers comprising the insole padding 102 are vertically oriented. In some embodiments, at least 97% of the fibers comprising insole padding 102 are vertically oriented. In some embodiments, at least 95% of the fibers comprising insole padding 102 are vertically oriented. In some embodiments, at least 94% of the fibers comprising insole padding 102 are vertically oriented. In some embodiments, at least 93% of the fibers comprising insole padding 102 are vertically oriented. In some embodiments, at least 92% of the fibers comprising insole padding 102 are vertically oriented. In some embodiments, at least 91% of the fibers comprising insole padding 102 are vertically oriented. In some embodiments, at least 90% of the fibers comprising insole padding 102 are vertically oriented. In some embodiments, the vertically oriented fibers may be oriented in a vertical direction which is at an angle of about 88° with respect to the top surface 104 and/or bottom surface 106 of the insole padding. In some embodiments, the vertically oriented fibers may be oriented in a vertical direction which is at an angle of about 86° with respect to the top surface 104 and/or bottom surface 106 of the insole padding. In some embodiments, the vertically oriented fibers may be oriented in a vertical direction which is at an angle of about 84° with respect to the top surface 104 and/or bottom surface 106 of the insole padding. In some embodiments, the vertically oriented fibers may be oriented in a vertical direction which is at an angle of about 82° with respect to the top surface 104 and/or bottom surface 106 of the insole padding. In some embodiments, the vertically oriented fibers may be oriented in a vertical direction which is at an angle between of about 82° and 75° with respect to the top surface 104 and/or bottom surface 106 of the insole padding. In some embodiments, the fibers comprising insole padding 102 may be oriented at a different angle such as horizontally or randomly oriented.

In some embodiments, the insole padding 102 may not include any chemical bonding agents or layers (e.g., boards) for bonding the fibers comprising insole padding 102 to one another. In some embodiments, the fibers comprising insole padding 102 are bonded to one another through mechanical and/or thermal bonding. In some embodiments, the insole padding 102 does not include any chemicals, such as chemical blowing agents used in conventional flexible foam manufacturing.

In one embodiment, the fibers comprising the insole padding 102 are elastomeric polyester fibers. In some embodiments, the insole padding 102 may be comprised of a recycled material (e.g., recycled fibers). In some embodiments, the insole padding 102 is comprised entirely of recycled fibers. In some embodiments, the insole padding 102 is comprised of about 95% recycled fibers. In some embodiments, the insole padding 102 is comprised of 90% recycled fibers. In other embodiments, the insole padding 102 is comprised of recyclable fibers. In some embodiments, the insole padding 102 is entirely comprised of recyclable fibers. In some embodiments, the insole padding 102 is comprised of 95% recyclable fibers. In some embodiments, the insole padding 102 is comprised of 90% recyclable fibers.

In some embodiments, the insole padding 102 may be comprised of cotton, polyester, nylon, or a combination thereof. In some embodiments, the insole padding 102 may be comprised of a biodegradable material. For example, the fibers comprising insole padding 102 may be made from a biodegradable material (e.g., cotton). In some embodiments, the insole padding 102 may be entirely comprised of a single type of fiber and/or material. For example, in some embodiments, the insole padding 102 may be entirely comprised of cotton fibers.

In some embodiments, the insole padding 102 may be colorized to suit any desirable aesthetic. For example, the fibers forming the foam-like fiber structure may be dyes, or colorized, to suit any desirable aesthetic (e.g., combinations of fibers having the same or different colors may be used). In some embodiments, shoe insole padding 102 may include an antimicrobial agent configured to prevent foot odor that is associated with the continued wearing of shoe insoles 100. In some embodiments, the antimicrobial agent may be a naturally occurring antimicrobial agent such as peppermint oil or derivatives thereof. In some embodiments, the antimicrobial agent may be dispersed within the insole padding 102. In some embodiments, the insole padding 102 may be comprised of a hypoallergenic material. In some embodiments, insole 102 may be comprised of a flame-resistant material. In some embodiments, the insole padding 102 may be comprised of a material which is resistant to discoloration such as elusive yellowing.

The thickness of the insole 100, measured in a direction perpendicular to the top surface 104 and bottom surface 106, may be similar to existing foam insoles. In some embodiments, the insole padding 102 has a thickness in the range of about 1 millimeter to about 7 millimeters. In some embodiments, the insole padding 102 has a thickness in a range of about 2 millimeters to about 6 millimeters. In some embodiments, the insole padding 102 has a thickness in a range of about 3 millimeters to about 5 millimeters. In some embodiments, the insole padding 102 has a thickness of at least 3 millimeters. In some embodiments, the insole padding 102 has a thickness of at least 4 millimeters. In some embodiments, the insole padding 102 has a thickness of at least 5 millimeters. In some embodiments, the thickness the insole padding 102 is about 5 millimeters.

In some embodiments the density of the insole padding 102 is in the range of about 100 grams per square meter (GSM) to about 600 GSM. In some embodiments, the density of the insole padding 102 is in the range of about 150 GSM to about 550 GSM. In some embodiments, the density of the insole padding 102 is within a range of about 200 GSM to about 400 GSM. In some embodiments, the density of the insole padding 102 is in the range of about 250 GSM to about 350 GSM. In some embodiments, the density of the insole padding 102 is at least 100 GSM. In some embodiments, the density of the insole padding 102 is at least 150 GSM. In some embodiments, the density of the insole padding 102 is at least 200 GSM. In some embodiments, the density of the insole padding 102 is at least 250 GSM. In some embodiments, the density of the insole padding 102 is at least 300 GSM. In some embodiments, the density of the insole padding 102 is at least 350 GSM. In some embodiments, the density of the insole padding 102 is at least 400 GSM. In one embodiment, the density of the insole padding 102 is about 350 GSM.

In some embodiments, the insole padding 102 has a tensile strength in a range of about 35 kg/cm² to about 55 kg/cm². In some embodiments, the insole padding 102 has a tensile strength in a range of about 40 kg/cm² to about 50 kg/cm². In some embodiments, the insole padding 102 has a tensile strength of about 46 kg/cm². In some embodiments, the insole padding 102 has an elongation percentage in a range of about 20% to about 40%. In some embodiments, the insole padding 102 has an elongation percentage in a range of about 22% to about 38%. In some embodiments, the insole padding 102 has an elongation percentage in a range of about 24% to about 36%. In some embodiments, the insole padding 102 has an elongation percentage in a range of about 26% to about 34%. In some embodiments, the insole padding 102 has an elongation percentage in a range of about 28% to about 32%. In some embodiments, the insole padding 102 has an elongation percentage in a range of about 25% to about 30%. In some embodiments, the fibers comprising insole padding 102 have an elongation percentage of about 27%. In some embodiments, the insole padding 102 has a compression set that is less than 40%. In some embodiments, the insole padding 102 has a compression set that is less than 38%. In some embodiments, the insole padding 102 has a compression set that is less than 36%. In some embodiments, the insole padding 102 has a compression set that is less than 34%. In some embodiments, the insole padding 102 has a compression set that is less than 32%. In some embodiments, the insole padding 102 has a compression set that is less than 30%. In some embodiments, the insole padding 102 has a compression set that is less than 28%. In some embodiments, the insole padding 102 has a compression set that is less than 24%. In some embodiments, the insole padding 102 has a compression set that is less than 22%. In some embodiments, the insole padding 102 has a compression set that is less than 20%.

In some embodiments, the insole padding 102 has a compression set that is less than 28%, a thickness in a range between about 2 millimeters to about 6 millimeters, and a density in a range of about 250 GSM to about 450 GSM. In some embodiments, the insole padding 102 has a compression set that is less than 24%, a thickness in a range between about 3 millimeters to about 5 millimeters, and a density in a range of about 300 GSM to about 400 GSM. In one embodiment, the insole padding 102 has a compression set that is less than 20%, a thickness of at least 4 millimeters and a density of about 350 GSM.

The insole padding 102 may be configured to be generally more breathable, and lighter in weight than conventional flexible polyurethane foam insole padding. In some embodiments, the insole padding 102 may be configured to have performance properties that are as good or better than conventional flexible polyurethane foam insoles. In some embodiments, the insole padding 102 has an air permeance in a range of about 90 μL/Pa·s to about 100/Pa·s. In some embodiments, the insole padding 102 has an air permeance in a range of about 92 μL/Pa·s to about 98 μL/Pa·s. In some embodiments, the insole padding 102 has an air permeance in a range of about 94/Pa·s to about 96 μL/Pa·s. In one embodiment, the air permeance of the insole padding 102 is about 95/Pa·s. In some embodiments, the insole padding 102 has a specific gravity in a range of about 0.13 g/cm³ to about 0.16 g/cm³. In some embodiments, the insole padding 102 has a specific gravity in a range of about 0.14 g/cm³ to about 0.15 g/cm³.

In some embodiments, the insole padding 102 may have a pattern and/or shape caused by a molding and/or heating process that the insole padding 102 is subjected to during manufacture. For example, the top surface 104 of the insole padding 102 may have a generally quilted pattern as shown in FIG. 1A that is caused by a heating process the insole padding 102 is subjected to during manufacture. In some embodiments, the insole padding 102 is molded and/or cut to have a shape that generally corresponds to the shape of a bottom of a wearer's foot. For example, the insole padding 102 is molded and/or cut to have a heel section 108 having a generally concave shape corresponding the shape of the bottom of the heel of a wearer's foot. The insole padding 102 may be molded and/or cut to have a toe section 112 which is generally flat and shaped generally similar to the outline of a wearer's forefoot (e.g., toes and ball of foot). The insole padding may be molded and/or cut to have an arch section 110 that is generally convex in shape and extends from the heel section 108 to the toe section 112. The arch section 110 may be shaped and/or sized to correspond to the shape and/or size of the arch of a wearer's foot.

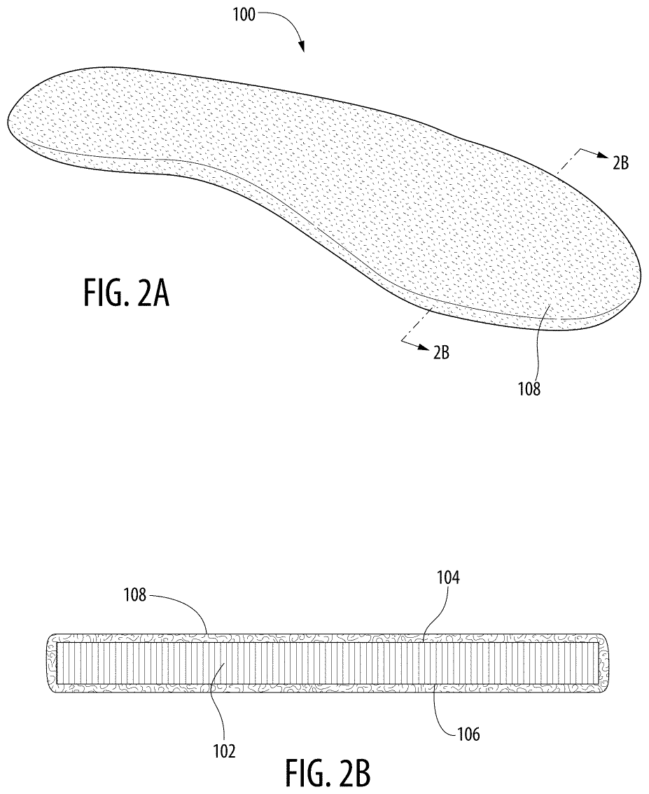

Referring to FIG. 2A-2B, the shoe insole 100 may include an optional sock-like cover 108 coupled to the insole padding 102. The sock-like cover 108 may provide additional comfort to a user of the shoe insole 100, absorb sweat produced by the user's foot, and/or reduce odor produced by the user's foot. Sock-like, as discussed herein, may refer to a knitted and/or woven fabric structure that is configured to at least partially encapsulate or entirely encapsulate a core (e.g., the insole padding 102). In some embodiments, the sock-like cover 108 is coupled to the insole padding 102 such that the sock-like cover 108 at least partially encapsulates the insole padding 102. In some embodiments, the sock like-cover 108 completely encapsulates the insole padding 102. In some embodiments, sock-like cover 108 is configured to cover the entire top surface 104 of the insole padding 102. In some embodiments, the sock-like cover 108 is configured to be selectively removable from the insole padding. For example, the sock-like cover 108 may include an opening (e.g., a hole or slot under the insole padding by the heel) such that the insole padding 102 may be inserted into or removed from the sock-like cover 108. In other embodiments, the sock-like cover 108 is mechanically coupled to the insole padding 102 (e.g., sewn or stitched onto the insole padding 102). In some embodiments, insole padding 102 and sock-like cover 108 are coupled together such that both may be removed from a shoe simultaneously by a user. In some embodiments, the sock-like cover 108 may be omitted entirely or provided as a separate accessory.

In some embodiments, the thickness of sock-like cover 108 is in a range of about 0.5 millimeters to about 4.0 millimeters. In some embodiments, the thickness of the sock-like cover 108 is in a range of about 1.0 millimeters to about 3.5 millimeters. In some embodiments, the thickness of the sock-like cover 108 is in a range of about 1.5 millimeters to about 3.0 millimeters. In some embodiments, the thickness of sock-like cover 108 may be in a range of about 2.0 millimeters to about 2.5 millimeters. In some embodiments, the thickness of sock-like cover 108 is at least 0.5 millimeters. In some embodiments, the thickness of sock-like cover 108 is at least 1.0 millimeters. In some embodiments, the thickness of sock-like cover 108 is at least 1.3 millimeters. In one embodiment, the thickness of sock-like cover 108 is about 0.7 millimeters.

In some embodiments, the thickness of the shoe insole 100 including the insole padding 102 encapsulated by the sock-like cover 108 is in a range of about 4 millimeters to about 8 millimeters. In some embodiments, the thickness of the shoe insole 100 including the insole padding 102 encapsulated by the sock-like cover 108 is in a range of about 5 millimeters to about 7 millimeters. In some embodiments, the thickness of the shoe insole 100 including the insole padding 102 encapsulated by the sock-like cover 108 is about 6 millimeters. In some embodiments, the thickness of the shoe insole 100 including the insole padding 102 encapsulated by the sock-like cover 108 is at least 3 millimeters. In some embodiments, the thickness of the shoe insole 100 including the insole padding 102 encapsulated by the sock-like cover 108 is at least 4 millimeters. In some embodiments, the thickness of the shoe insole 100 including the insole padding 102 encapsulated by the sock-like cover 108 is at least 5 millimeters. In some embodiments, the thickness of the shoe insole 100 including the insole padding 102 encapsulated by the sock-like cover 108 is at least 6 millimeters.

The sock-like cover 108 may be comprised of recycled and/or recyclable materials (e.g., recycled fibers). In some embodiments, the sock-like cover 108 is comprised entirely of recycled fibers. In some embodiments, the sock-like cover 108 is comprised of about 95% recycled fibers. In some embodiments, the sock-like cover 108 is comprised of 90% recycled fibers. In other embodiments, the sock-like cover 108 is comprised of recyclable fibers. In some embodiments, the sock-like cover 108 is entirely comprised of recyclable fibers. In some embodiments, the sock-like cover 108 is comprised of 95% recyclable fibers. In some embodiments, the sock-like cover 108 is comprised of 90% recyclable fibers.

The insole padding 102 and the sock-like cover 108 may be comprised of the same types of material as one another. In one embodiment, the insole padding 102 and sock-like cover 108 may be comprised of the same types of fibers. In one embodiment, the insole padding 102 and the sock-like cover are comprised of the same recycled materials and/or recycled fibers to ensure that the shoe insole 100 is entirely recyclable or biodegradable. In some embodiments, the sock-like cover 108 is comprised of fibers such as, but are not limited to, polyester, nylon, and wool. In some embodiments, a combination of two or more fibers combinations are included in the sock-like cover 108. In some embodiments, the sock-like cover may be comprised of fibers of the same type (e.g., polyester) having different levels of elasticity. For example, fibers of the same type (e.g., polyester) may have different levels of elasticity resulting from different treatment and/or manufacturing methods. A single type of fiber may have different elasticity values by a tighter knit/weave, by introduction of another fiber in the knit/weave, or by introduction of stiffening products, such as starch.

In some embodiments, the sock-like cover 108 is comprised of materials configured to improve one or more properties of the insole padding 102. For example, the sock-like cover 108 may be comprised of an absorbent material configured to absorb moisture (e.g., sweat) from the bottom of a user's foot. The sock-like cover 108 may be comprised of a material configured to protect the insole padding 102 from tears, discoloration, and/or warping. The sock-like cover 108 may be comprised of a material configured to improve the ornamental appearance of insole padding 102. For example, the sock-like cover 108 may be a material that can be died, printed on, or woven in an aesthetically beneficial pattern. The sock-like cover 108 may include a non-slip material to resist movement of a user's foot relative to the sock-like cover 108 when worn. The sock-like cover 108 may be comprised of a softer and/or stiffer material than the insole padding 102 in order to provide two stages of compression in combination with the insole padding 102 when worn by a user. In some embodiments, the sock-like cover 108 is configured to be replaceable with another sock-like cover.

In some embodiments, the shoe insole 100 may reduce the environmental impact of shoe components and reduce the shoe-wearer's environmental impact. In some embodiments, the shoe insole 100 is comprised of a single material type (e.g., fibers) which may adhere to the sustainable practices of a closed-loop manufacturing system. Furthermore, by providing an insole padding 102 encapsulated by a sock-like cover 108, the number of socks that the shoe wearer must own and/or use may be reduced thereby reducing consumer consumption. Put another way, the shoe insole 100 may allow fewer products to be owned and in rotation by the shoe wearer as shoe insole 100 may reduce and/or eliminate the need for the wearer to own or wear conventional socks.

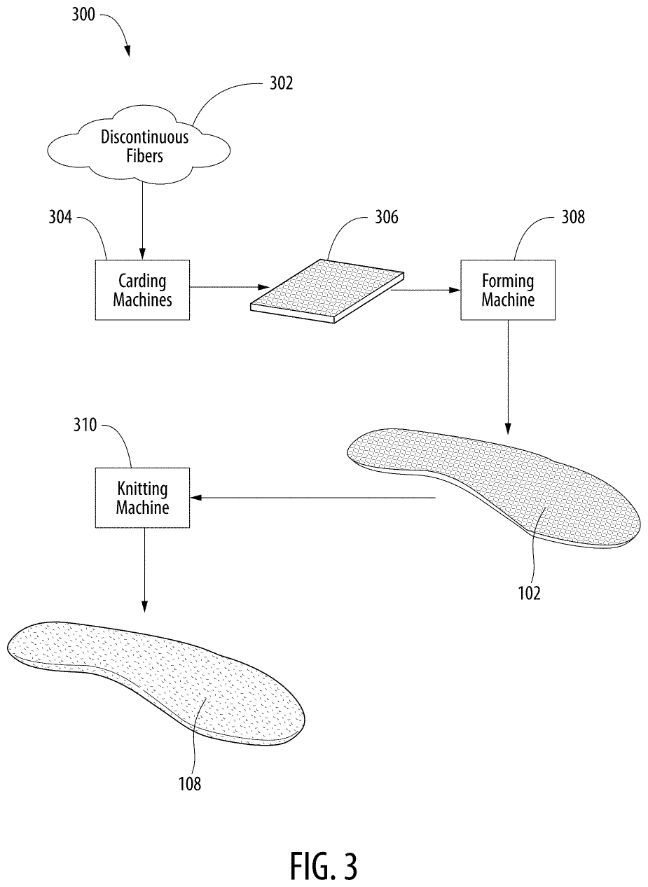

Referring to FIG. 3 there is shown a diagram of a system, generally designated 300, for forming the shoe insole padding 102 and encasing it within a sock-like cover 108. In some embodiments, a plurality of discontinuous fibers 302 may be provided to a carding machine 304. In some embodiments, the plurality of discontinuous fibers 302 may be comprised of a recycled material. In some embodiments, the carding machine 304 may be configured to arrange, separate and parallel orient the plurality of discontinuous fibers 302 such that the fibers are generally parallel with one another. In some embodiments, the plurality of discontinuous fibers 302 are parallel oriented in a vertically upright position by carding machine 304. In some embodiments, the parallel oriented fibers may be batted into a sheet of padding 306. In some embodiments, the sheet of padding 306 may formed to any desired thickness. In some embodiments, the sheet of padding 306 may have a thickness in the range of about 3 mm to about 6 mm. In some embodiments, the sheet of padding 306 may have a thickness of about 5 mm.

In some embodiments, the carding machine 304 may operate by mechanical machining, pneumatic machining, and/or by “air type” machining in which suction devices and/or blowers are used to vertically orient the fibers and configure the overall thickness of the fibers into continuous sheets. In some embodiments, the carding machine 304 operated by mechanical machining and/or pneumatic machining may be comprised of a first rotary licker-in component and a secondary rotary drum component (not shown). The first rotary licker-in and secondary rotary drum components may be configured to work the discontinuous fibers 302 in concert by passing them along a working path. In some embodiments, the carding machine 304 operated by “air type” machining may include air processing that is conducted by conveying the discontinuous fibers 302 in the proximity of suction devices or by conveying the discontinuous fibers 302 with the aid of blowers in the proximity of the suction devices.

The sheet of padding 306 may be produced into sheets of varying thicknesses and density to meet a given technical specification. In some embodiments, the sheet of padding 306 may be formed into an insole padding (e.g., insole padding 102). As discussed above, the carding machine 304 may be configured to arrange, separate, and parallel orient discontinuous fibers 302 in a vertically upright position to form the sheet of padding 306. In some embodiments, the sheet of fibers 306 may be intertwined in such a way to form a foam-like fiber structure where the fibers act as a foam-like structure. The foam-like fiber structure may have rebound and compression properties similar to known foam insoles while maintaining breathability, also known as air permeability. The foam-like fiber structure may require no use of chemicals in its assembly. The foam-like fiber structure may be made more or less dense in order to adhere to any desirable technical specification. In some embodiments, the foam-like fiber structure may utilize fibers having varying fiber diameters and varying fiber lengths in order to adhere to any desirable technical specification.

In some embodiments, the sheet of padding 306 may be provided to a type of forming machine 308 configured to form the sheet of padding 306 into a desired shape (e.g., the shape of insole padding 102). In some embodiments, the sheet of padding 306 may be formed into insole padding 102 by way of machine die-cutting, slicing, and/or molding via methods known by those skilled in the art. In some embodiments, the insole padding 102 may be formed to meet a given shoe size, shape and/or given shoe type. In some embodiments, the insole padding 102 may be steamed at a temperature in a range of about 160° C. to about 180° C., and in one embodiment, at a temperature of about 170° C., for between fifty to one-hundred seconds to soften the insole padding 102. In some embodiments, the softened insole padding 102 may be compression molded, via methods known to those skilled in the art, into a contoured shoe insole shape. In some embodiments, the contoured shoe insole shape may be die-cut into the shape of an individual insole padding 102. In some embodiments, the shape of the insole padding 102 may generally correspond to the shape of a bottom of a wearer's foot. In some embodiments, the insole padding 102 may have a heel section having a generally concave shape, a toe section which is generally flat, and an arch section being generally convex in shape and extending from the heel section to the toe section.

In some embodiments, the insole padding 102 may be formed to generally match the bottom of a user's foot. In one embodiment, the forming machine 308 may be a device configured to perform machine die-cutting. The machine die-cutting device may be configured to machine stamp the sheet of padding 306 into the shape of the insole padding 102 for a given size (e.g., for a given shoe size). In some embodiments, the insole padding 102 may be provided (e.g, manually fed) to a knitting machine 310. In some embodiments, the knitting machine 310 may be configured to construct a knitted sock-like cover (e.g., sock-like cover 108) around the insole padding 102 such that the insole padding 102 is at least partially encased by the sock-like cover. In some embodiments, the knitting machine 310 is configured to completely encase insole padding 102 in sock-like cover 108. In some embodiments, the insole padding 102 and sock-like cover 108 produced by system 300 may be machine washable and dryable. In some embodiments, the insole padding 102 and sock-like cover 108 may be comprised of the same material or materials.

In some embodiments, the fibers comprising insole padding 102 and/or sock-like cover 108 may be elastomeric fibers. In some embodiments, the fibers comprising insole padding 102 and/or sock-like cover 108 may be a blend of one or more types of elastomeric fibers. In some embodiments, the fibers comprising insole padding 102 are a blend of about 75% 1.5 denier polyester fibers and about 25% 2 denier bicomponent fibers. In some embodiments, the fibers comprising insole padding 102 are a blend of about 80% 6 denier polyester fibers and about 20% 4 denier bicomponent fibers. In some embodiments, the fibers comprising insole padding 102 are a blend of about 80% 15 denier polyester fibers and about 20%4 denier bicomponent fibers. In some embodiments, the fibers comprising insole padding 102 are a blend of about 80% 25 denier polyester fibers and about 20% 4 denier bicomponent fibers.

In some embodiments, the fibers comprising insole padding 102 and/or sock-like cover 108 may be blended with other types of fibers to suit a given need. For example, the use of natural fibers such as jute, flax hemp, or cotton may be desirable for certain conditions. Other materials such as high-technology fibers (e.g., Kevlar, and Dyneema) may be desirable for certain conditions. In some embodiments, any fiber type, suitable to a given market need, may be utilized, whether blended with or used on its own to form the insole padding 102 and/or the sock-like cover 108. In some embodiments, the insole padding 102 and sock-like cover 108 may be comprised of a fully biodegradable or fully recyclable structural fiber such that shoe insole 100 is fully biodegradable or fully recyclable. In some embodiments, a fabric top sheet (not shown) may be coupled to the top surface 104 of insole padding 102. In some embodiments, the fabric top sheet may be coupled to the top surface 104 of the insole padding 102 by way of hot-melt adhesion (melting like materials together until they fuse).

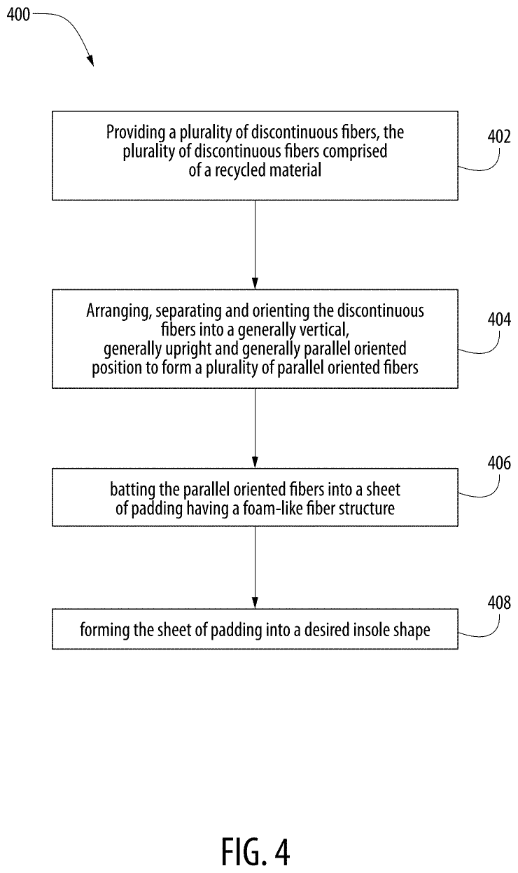

Referring to FIG. 4, in some embodiments, there is a method, generally designated 400, of forming a machine washable shoe insole (e.g., shoe insole 100), in accordance with an exemplary embodiment of the present disclosure. In some embodiments, prior to method 400, one or more suitable types of fibers may be selected. In some embodiments, suitable fibers may be selected based on fiber type, fiber diameter, fiber color, and/or fiber length. In some embodiments, the suitable fiber may be an elastomeric fiber. In some embodiments, a plurality of the suitable fiber (e.g., an elastomeric fiber) may be used in the method 400. In some embodiments, the method 400 includes the step 402 of providing a plurality of discontinuous fibers, the plurality of discontinuous fibers comprised of a recycled material. For example, discontinuous fiber 302 may be provided to carding machine 304 as described above with reference to FIG. 3. In some embodiments, the plurality of discontinuous fibers are comprised of the selected suitable fiber(s).

In some embodiments, the method 400 may include the step 404 of arranging, separating and orienting the discontinuous fibers into a generally vertical, generally upright and generally parallel oriented position to form a plurality of parallel oriented fibers. For example, the carding machine 304 may be configured to arrange, separate, and orient discontinuous fibers 302 into a generally vertical, generally upright, and generally parallel oriented position. In some embodiments, the method 400 may include the step 406 of batting the parallel oriented fibers into a sheet of padding having a foam-like fiber structure. For example, the parallel oriented fibers produced by carding machine 304 may be batted into a sheet of padding 306. The fibers forming the sheet of padding 306 may be intertwined to form a foam-like fiber structure. In some embodiments, the method 400 may include the step 408 of forming the sheet of padding into a desired insole shape. For example, the sheet of padding 306 may be provided to a forming machine 308 configured to form the sheet of padding 306 into the shape of insole padding 102. In some embodiments, the method 400 may include encasing the sheet of padding formed into the desired insole shape in a sock-like cover. For example, insole padding 102 may be provided to knitting machine 310, which may be configured to encase insole padding 102 in sock-like cover 108.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

1. A shoe insole comprising:
an insole padding having a bottom surface and a top surface and comprised of non-woven fibers, the non-woven fibers being generally vertically oriented relative to the bottom surface and the top surface of the insole padding;
wherein the non-woven fiber is comprised of elastomeric polyester fibers.

2. The shoe insole of claim 1 further comprising:
a knitted cover at least partially encapsulating the insole padding.

3. The shoe insole of claim 2, wherein the knitted cover is comprised of the same type of fiber as the insole padding.

4. The shoe insole of claim 2, wherein the knitted cover completely encapsulates the insole padding.

5. The shoe insole of claim 1, wherein the non-woven fibers are comprised of a recycled material.

6. The shoe insole of claim 1, wherein the insole is solely held together through mechanical forces and thermal bonding.

7. The shoe insole of claim 1, wherein the shoe insole does not include any chemical-derived foams or adhesives.

8. The shoe insole of claim 1, wherein the entire shoe insole is biodegradable.

9. The shoe insole of claim 1, wherein the entire shoe insole is comprised of a single type of material.

10. The shoe insole of claim 1, wherein the non-woven fiber is comprised of one or more of cotton, polyester, and nylon.

11. (canceled)

12. The shoe insole of claim 1, wherein the insole padding has a specific gravity in a range of about 0.13 g/cm3 to about 0.16 g/cm3.

13. The shoe insole of claim 1, wherein the insole padding having an air permeance in a range of about 92 μL/Pa·s to about 98 μL/Pa·s.

14. The shoe insole of claim 1, wherein the insole padding has a thickness in a range of about 4 millimeters to about 6 millimeters.

15. The shoe insole of claim 1, wherein the insole padding has a thickness of at least 4 millimeters.

16. The shoe insole of claim 1, wherein the insole padding includes a heel section having a generally concave shape, a toe section which is generally flat, and an arch section being generally convex in shape and extending from the heel section to the toe section.

17. A shoe insole comprising:
an insole padding comprised of non-woven fibers comprised of elastomeric polymer fibers; and
a cover at least partially encapsulating the insole padding, the cover comprised of knitted elastomeric polymer fibers, the elastomeric polymer fibers of the cover being the same material as the elastomeric polymer fibers of the insole padding,
wherein the shoe insole does not include any foam material or adhesives, and wherein the insole padding has an air permeance in a range of about 92 μL/Pa·s to about 98 μL/Pa·s and a thickness in a range of at least 4 millimeters.

18. The shoe insole of claim 17, wherein the non-woven fibers of the insole padding are generally vertically oriented relative to a bottom surface of the insole padding.

19-31. (canceled)
